(19) United States
(12) Patent Application Publication
(10) Pub. No.: US 2011/0301719 A1
(43) Pub. Date: Dec. 8, 2011

(54) PARAMETER SETTING DEVICE

(75) Inventor: Yusuke Kuroda, Tokyo (JP)

(73) Assignee: MITSUBISHI ELECTRIC CORPORATION, Chiyoda-ku, Tokyo (JP)

(21) Appl. No.: 13/202,042

(22) PCT Filed: Dec. 10, 2009
(86) PCT No.: PCT/JP2009/070682

§ 371 Date: Aug. 17, 2011

(30) Foreign Application Priority Data
Mar. 25, 2009 (JP) 2009-074445

(51) Int. Cl. G05B 19/042

(52) U.S. Cl. 700/7

(57) ABSTRACT

To collectively set multi-CPU parameters included in a project of each CPU having a multi-CPU relationship, a parameter setting device includes: unit configuration information used for managing, for each PLC, unit information in which a CPU and a project allocated to the CPU are associated with each other; a unit-configuration analyzing unit that extracts a list of unit information on CPUs provided in a same PLC that includes a CPU specified by a user from the unit configuration information; and a parameter writing unit that acquires each project of CPUs provided in a same PLC that includes the CPU based on the extracted list of unit information when a parameter of a project of the specified CPU is set, and sets a setting content, which is same as a setting content regarding a project of the specified CPU, to each of the acquired projects.

### FIELD

The present invention relates to a parameter setting device that sets a parameter to a project of a CPU unit provided in a programmable controller (PLC) that controls an industrial machine and the like.

### BACKGROUND

Conventionally, a programmable controller (PLC) has been used as a controller for an industrial machine and the like. The PLC includes a plurality of unit parts. Specifically, the PLC is configured by appropriately combining various unit parts such as a power source unit as a power supply source, a CPU unit that manages control of the entire PLC, a motion CPU unit that controls a servo motor via a servo amplifier attached to a drive unit of a production unit or facilities, an input unit that inputs signals of a switch and a sensor attached to appropriate locations of the production unit or facilities, an output unit that outputs a control output to an actuator, and a communication unit for connecting the PLC to a communication network.

Control in the CPU unit in the PLC is performed so as to take in a signal input by the input unit to an I/O memory of the CPU unit, to perform a logical operation based on a pre-registered user program, to write an operation execution result in the I/O memory and send it to the output unit, and thereafter to perform so-called peripheral processing, cyclically and repeatedly.

Further, control in the motion CPU unit is performed so as to repeat a predetermined operation such that a motion command is generated based on a user program incorporated in the unit in a pre-registered motion program language, a command result is sent to the servo amplifier to control the servo motor via the servo amplifier, and the state of the servo motor such as the speed and position thereof is sent back to the motion CPU unit. Hereinafter, the CPU unit and the motion CPU unit are occasionally referred to collectively as “CPU”. In addition, the unit part is occasionally referred simply as “unit”.

A project is allocated to the CPU mentioned above per unit by operating on a PLC configuration diagram displayed on a programming device (a parameter setting device) that performs setting of each unit in the PLC. The project means a setting file required for operations of the CPU, and the project is allocated to respective CPUs. The CPU operates with an intended operation of a user by setting various parameters to be used for each project. The user sets a parameter to each project according to a target system.

On the PLC configuration diagram, it is possible to create a multi-CPU environment to be operated while maintaining relevance between a plurality of CPUs. In the multi-CPU environment, it is required to set the same multi-CPU parameter between the CPUs having relevance. By setting the same multi-CPU parameter, it is guaranteed that each CPU unit operates normally.

The multi-CPU parameter described above is stored in each project, and downloaded in each CPU unit or motion CPU unit in the PLC via a communication line. When inconsistency occurs in the set CPU parameters, the user uses an operational application to check the parameter set to the individual project, finds a defective portion, and performs a correction operation. The corrected CPU parameter is downloaded again in each CPU unit or motion CPU unit in the PLC.

As a technique for reducing a load for parameter setting, there are disclosed a device that can collectively set parameters, which need to be commonly set to the CPU unit and an I/O unit, with respect to a plurality of units by one operation (Patent Literature 1), and a device that arranges a CPU on a network configuration and sets a parameter to an individual device (Patent Literature 2).

### CITATION LIST

### Patent Literatures

Patent Literature 1: Japanese Patent Application Laid-open No. 2008-186206

Patent Literature 2: Japanese Patent Application Laid-open No. 2005-327237

### SUMMARY

### Technical Problem

However, according to the technique disclosed in Patent Literature 1, setting with respect to a plurality of units in a single project is assumed, and parameters cannot be collectively set between a plurality of projects configuring a multi-CPU environment. Further, when a parameter, which is set to a project allocated to an individual CPU unit, is changed after having set the parameters to a plurality of units, changes of parameters with respect to other projects need to be reflected individually with respect to each project by using an individual operational application.

Further, according to the technique disclosed in Patent Literature 2, a mechanism for providing relevance between devices arranged in the same base unit on a network configuration diagram is not assumed, and when it is desired to set parameters to a plurality of devices at the same time, parameter setting needs to be performed separately by opening a setting screen for the individual device. When a multi-CPU parameter is to be set, a project that is not operated by the user needs to be handled. When the project is used by another user, parameter setting cannot be performed. Therefore, the use status of the project needs to be ascertained beforehand.

The present invention has been made in view of the above problems, and an object of the present invention is to provide a parameter setting device that can collectively set multi-CPU parameters included in a project of each CPU having a multi-CPU relationship.

### Solution to Problem

To solve the problem and achieve an object, there is provided a parameter setting device that sets a parameter of a plurality of projects for respectively operating a plurality of CPUs provided in a programmable controller (PLC), the parameter being required for the CPUs to operate in conjunction with each other, with respect to each of the projects, the parameter setting device including: unit configuration information used for managing for each PLC unit information in which a CPU and a project allocated to the CPU are associated with each other; a unit-configuration analyzing unit that extracts a list of unit information on CPUs provided in a same PLC that includes a CPU specified by a user from the unit configuration information; and a parameter writing unit that acquires each project of CPU units, which are provided in a same PLC in which the CPU is included, based on the extracted list of unit information, when a parameter of a project of the specified CPU is set, and sets a setting content, which is same as a setting content regarding a project of the specified CPU, to each of the acquired projects. cl ADVANTAGEOUS EFFECTS OF INVENTION

According to the present invention, it is possible to provide a parameter setting device that can collectively set multi-CPU parameters included in a project of each CPU having a multi-CPU relationship.

### BRIEF DESCRIPTION OF DRAWINGS

FIG. 1 is a block diagram explaining a hardware configuration of a parameter setting device according to an embodiment of the present invention.

FIG. 2 is a block diagram explaining a functional configuration of the parameter setting device according to the embodiment of the present invention.

FIG. 3 depicts a display screen displayed on a display device.

FIG. 4 is a display example of a parameter-setting-information display unit.

FIG. 5 is an example of unit parts information stored in a unit-parts-information storage unit.

FIG. 6 is a detailed explanatory diagram of unit configuration information.

FIG. 7 is a detailed explanatory diagram of multi-CPU parameter information.

FIG. 8 depicts a file configuration of a work space and a project.

FIG. 9 is an explanatory diagram of a PLC configuration diagram.

FIG. 10 is a flowchart explaining an operation of a project allocating unit.

FIG. 11 is a flowchart explaining an operation of a unit-configuration analyzing unit.

FIG. 12 is a flowchart explaining an operation of a project acquiring unit.

FIG. 13 is a flowchart explaining an operation of a parameter reading unit.

FIG. 14 is a flowchart explaining an operation of a parameter writing unit.

FIG. 15 is a flowchart explaining an operation of the parameter setting device according to the embodiment of the present invention to collectively set parameters.

FIG. 16 is a flowchart explaining an operation of a consistency checking unit.

FIG. 17 is a flowchart explaining an operation of a project-usage-status checking unit.

### DESCRIPTION OF EMBODIMENTS

Exemplary embodiments of a parameter setting device according to the present invention will be explained below in detail with reference to the accompanying drawings. The present invention is not limited to the embodiments.

### Embodiment

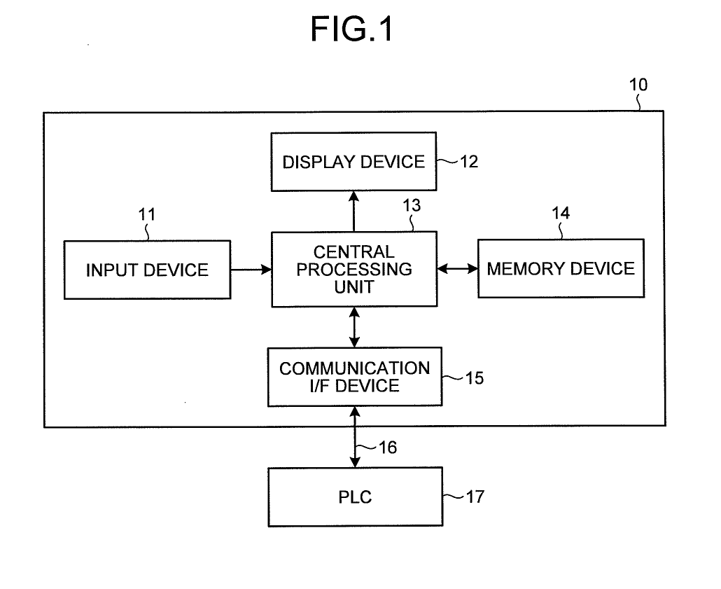

FIG. 1 is a block diagram explaining a hardware configuration of a parameter setting device according to an embodiment of the present invention.

In FIG. 1, a parameter setting device 10 is connected to a PLC (a CPU unit or a motion CPU unit in the PLC) 17 via a predetermined communication line 16. The communication line 16 is realized by direct cable connection by using a serial line, such as RS232C. However, the connection is not limited to direct connection, and can have a configuration in which the PLC 17 and the parameter setting device 10 are connected to each other via a network by using other communication lines.

The parameter setting device 10 has a function of allocating a project, which is a setting file of a CPU unit or a motion CPU unit in the PLC; a function of setting the same multi-CPU parameter to a plurality of CPU units or motion CPU units connected to the PLC; and a function of downloading the set parameter to the PLC 17 via the communication line 16.

The parameter setting device 10 executes a predetermined program to realize these functions. As the hardware configuration thereof, the parameter setting device 10 includes an input device 11 such as a keyboard or a pointing device, a display device 12, a central processing unit 13, a memory device 14, and a communication interface (I/F) device 15. Although not shown, the memory device 14 includes a nonvolatile memory device and a volatile memory device, and the nonvolatile memory device stores pieces of project information, unit configuration information and the like. The volatile memory device is appropriately used as a work memory at the time of execution by the central processing unit 13. The communication I/F device 15 communicates with the PLC 17 via the communication line 16.

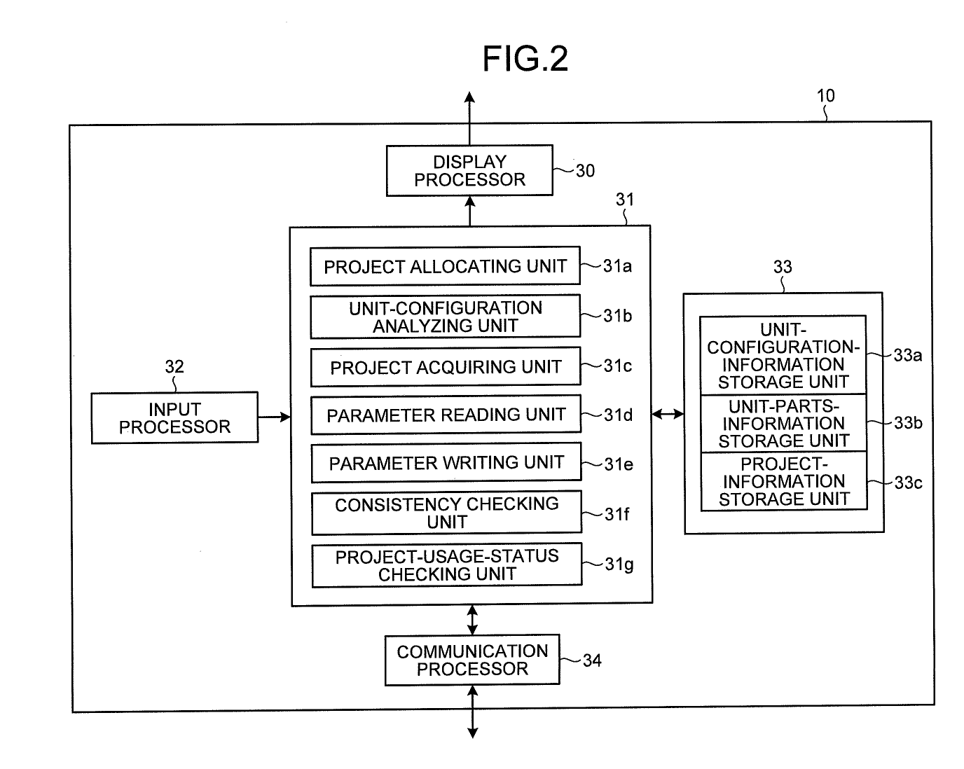

FIG. 2 is a block diagram explaining functions of the parameter setting device 10 realized by cooperation of the central processing unit 13 and the memory device 14. The parameter setting device 10 includes an input processor 32 that processes an input from the input device 11, a display processor 30 that creates display data to be output to the display device 12, an arithmetic unit 31 that executes respective functions, a storage unit 33 that stores calculation results, project data and the like, and a communication processor 34 that processes communication with the PLC. The arithmetic unit 31 includes a project allocating unit 31a, a unit-configuration analyzing unit 31b, a project acquiring unit 31c, a parameter reading unit 31d, a parameter writing unit 31e, a consistency checking unit 31f, and a project-usage-status checking unit 31g.

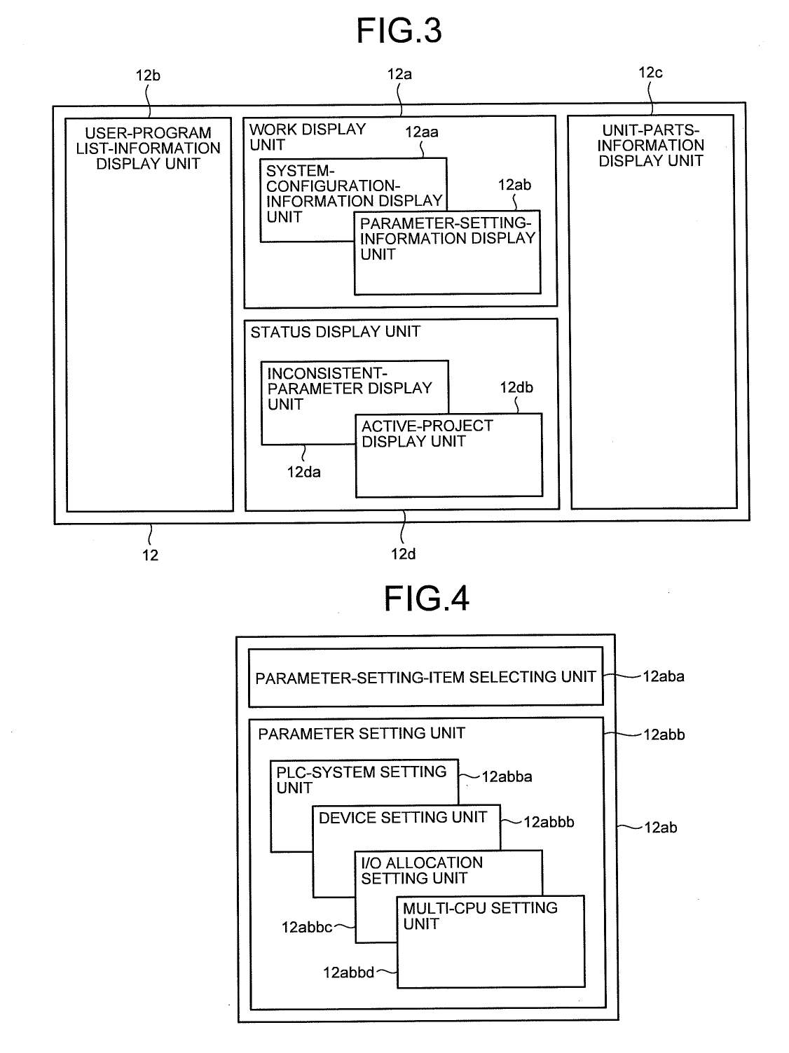

FIG. 3 depicts a display screen displayed on the display device 12. As shown in FIG. 3, included are a work display unit 12a that performs editing work such as creation of a user program included in the respective peaces of project data and creation of unit configuration information, a user-program list-information display unit 12b that displays a list of all user programs downloaded in the PLC, a unit-parts-information display unit 12c that displays list information of unit parts required for configuring the PLC, and a status display unit 12d that displays a processing state in the parameter setting device 10 such as inconsistency of multi-CPU parameters, activation check results of a project and the like.

The work display unit 12a includes a system-configuration-information display unit 12aa that displays system configuration information for creating the configuration of the PLC and a network configuration, and a parameter-setting-information display unit 12ab. The status display unit 12d includes an inconsistent-parameter display unit 12da that displays a list of inconsistent parameters, and an active-project display unit 12db that displays a result of usage status check of a project.

Integrated display is output and shown on the parameter-setting-information display unit 12ab regardless of the unit configuration and contents of target project data. There is a difference in the type of parameters set in a sequencer CPU unit and the motion CPU unit. However, the display screen of the parameter-setting-information display unit 12ab displays all parameters, which require same setting between projects having relevance, to prompt an input. Parameters supposed to be set among the input parameters are divided into each type of project in the parameter setting device 10 and set to the project allocated to each CPU (a CPU unit or a motion CPU unit).

Information of the PLC configuration diagram displayed on the system-configuration-information display unit 12aa is created as unit configuration information by the arithmetic unit 31, and stored in a unit-configuration-information storage unit 33a. The unit configuration information includes a plurality of unit configuration tables in which pieces of information relating to the unit configuration for each PLC are associated with each other. Each unit configuration table corresponds to each one PLC configuration diagram, and a PLC configuration name, which is the name of each PLC, is added thereto. Each configuration unit in the PLC configuration diagram respectively has unit information, and is associated with a unit name included in the unit information. The display processor 30 performs graphical processing based on the unit configuration table read from the unit-configuration-information storage unit 33a and displays on the system-configuration-information display unit 12aa. The unit configuration information and the components thereof are described later.

A list of the multi-CPU parameters displayed on the parameter-setting-information display unit 12ab is created as multi-CPU parameter information by the arithmetic unit 31, and stored in a parameter setting position in a project-information storage unit 33c. The display processor 30 extracts the multi-CPU parameter based on the multi-CPU parameter information read from the project-information storage unit 33c, and displays the multi-CPU parameter on the parameter-setting-information display unit 12ab. The multi-CPU parameter information is described later.

The unit parts information displayed on the unit-parts-information display unit 12c is stored beforehand in a unit-parts-information storage unit 33b. The display processor 30 reads the unit parts information from the unit-parts-information storage unit 33b, and displays the read unit parts information on the unit-parts-information display unit 12c. In the present embodiment of the present invention, the unit parts information is stored beforehand; in addition, the parameter setting device also has a function of adding and storing the unit parts information later.

FIG. 4 is a display example of the parameter-setting-information display unit 12ab. As shown in FIG. 4, the parameter-setting-information display unit 12ab includes a parameter-setting-item selecting unit 12aba that specifies a group to be set from the grouped parameter setting items, and a parameter setting unit 12abb that displays the parameter setting items. The parameter setting unit 12abb includes a PLC-system setting unit 12abba that sets a PLC system-related parameter, a device setting unit 12abbb that sets a device-related parameter, an I/O allocation setting unit 12abbc that sets an I/O allocation-related parameter, and a multi-CPU setting unit 12abbd that sets a multi-CPU-related parameter.

Pieces of setting information of a plurality of groups can be displayed on the parameter setting unit 12abb by the operation of the parameter-setting-item selecting unit 12aba.

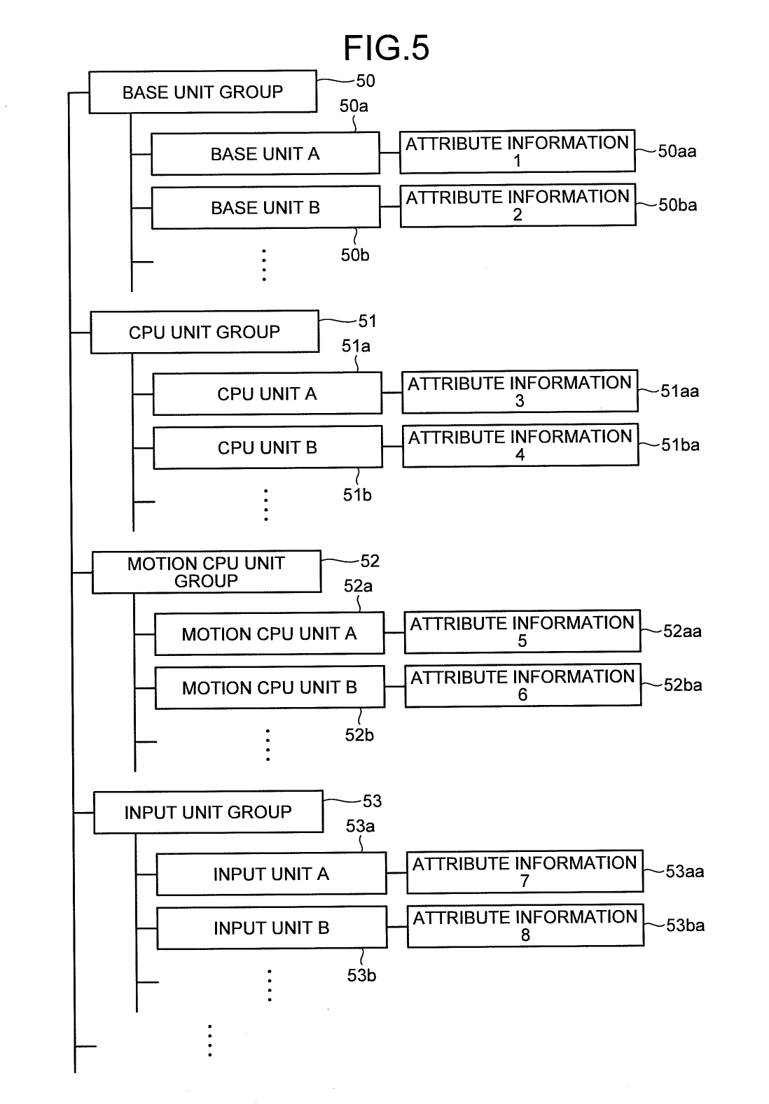

FIG. 5 is an example of the unit parts information stored in the unit-parts-information storage unit 33b. As shown in FIG. 5, the unit parts information includes a plurality of unit groups, and a plurality of pieces of unit definition information is included in one unit group. One piece of unit definition information includes a unit name and attribute information. The unit group includes a base unit group 50, a CPU unit group 51, a motion CPU unit group 52, and an input unit group 53. The unit group is for integrating the same type of unit definition information. The base unit group 50 includes a plurality of types of unit definition information such as a unit name of a base unit A (50a) and attribute information 1 (50aa), a unit name of a base unit B (50b) and attribute information 2 (50ba) and the like. The CPU unit group 51 includes a plurality of types of unit definition information such as CPU unit A (51a) and attribute information 3 (51aa), a CPU unit B (51b) and attribute information 4 (51ba) and the like. The motion CPU unit group 52 includes a plurality of types of unit definition information such as a motion CPU unit A (52a) and attribute information 5 (52aa), a motion CPU unit B (52b) and attribute information 6 (52ba) and the like. The input unit group 53 includes a plurality of types of unit definition information such as an input unit A (53a) and attribute information 7 (53aa), an input unit B (53b) and attribute information 8 (53ba) and the like. The unit parts information also includes unit groups and the unit definition information required for configuring the PLC.

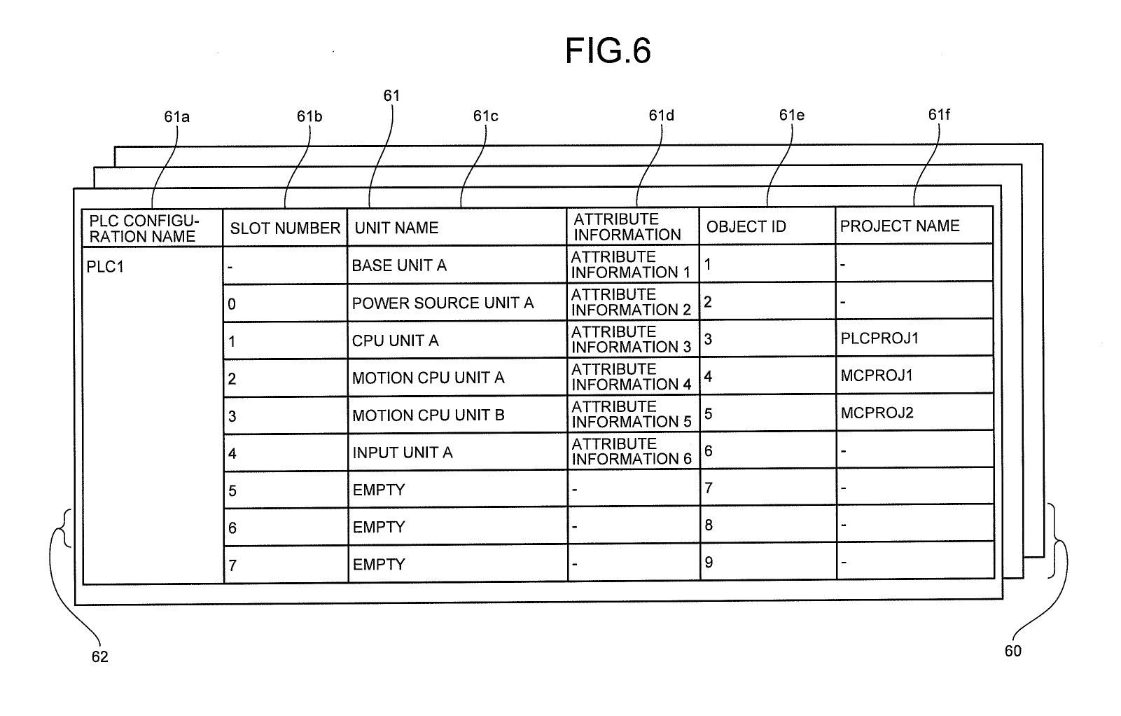

FIG. 6 is a detailed explanatory diagram of the unit configuration information. As shown in FIG. 6, the unit configuration information includes a plurality of unit configuration tables 61. The unit configuration table 61 indicates the configuration of one PLC and is a set of unit information 62, each of the unit information 62 including items of a PLC configuration name 61a, a slot number 61b, a unit name 61c, attribute information 61d, an object ID 61e, and a project name 61f. A list of unit parts arranged in each PLC configuration diagram 90 can be acquired by specifying the PLC configuration name 61a held in the unit information 62. It can be uniquely identified based on the unit name 61c in which a slot on the PLC configuration diagram 90 the unit part is arranged. A project name allocated to each CPU is stored in the project name 61f, and an allocation relationship between the CPU and the project can be ascertained by using a combination of the unit name 61c and the project name 61f.

The unit configuration table 61 is created at a timing when the PLC configuration diagram 90 is newly added on the system-configuration-information display unit 12aa. The unit information 62 is created at a timing when a unit part selected from the unit-parts-information display unit 12c is shifted to a base unit A (91) on the PLC configuration diagram 90. At this point in time, a user inputs the unit name 61c and the attribute information 61d. The slot number 61b and the object ID 61e are pieces of information added by the arithmetic unit 31 at the time of creating the unit information, and these values are set in the unit configuration table 61 by the arithmetic unit 31. The project name 61f is set by the project allocating unit 31a.

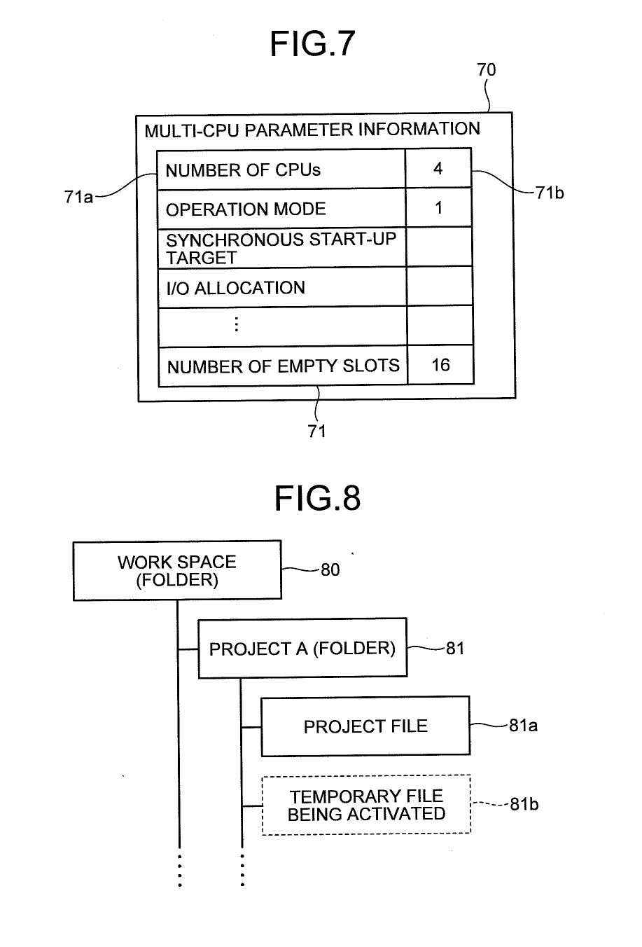

FIG. 7 is a detailed explanatory diagram of the multi-CPU parameter information. Multi-CPU parameter information 70 includes a plurality of parameter types 71a and parameter setting values 71b on a single multi-CPU parameter table 71. The multi-CPU parameter table 71 indicates a multi-CPU parameter configuration of a plurality of CPUs present on one PLC.

The file configuration of a work space and a project have a hierarchical structure as shown in FIG. 8. The work space indicates a framework having a plurality of projects coordinated by a user operation and a common setting of the respective projects, and a project folder 81 is created per project under a work space folder 80. A project file 81a and a temporary file 81b are managed under the project folder 81. Information such as a program included in a project, data including parameters, security setting per project, update history, and user information is managed in the project file 81a. The temporary file 81b is created at the time of activating the project and is deleted at the time of finishing the project. The project-usage-status checking unit 31g determines whether the project file 81a is being used by monitoring the temporary file 81b.

With respect to the project file 81a, a parameter can set by the parameter setting device 10. A parameter can also be set from an operation application for the individual project file 81a. Therefore, the multi-CPU parameter can be overwritten from each operational application after setting of the multi-CPU parameter by the parameter setting device 10. When the multi-CPU parameter is changed by each application, because there may be inconsistency in the multi-CPU parameters between projects, the consistency checking unit 31f checks whether there is any inconsistency.

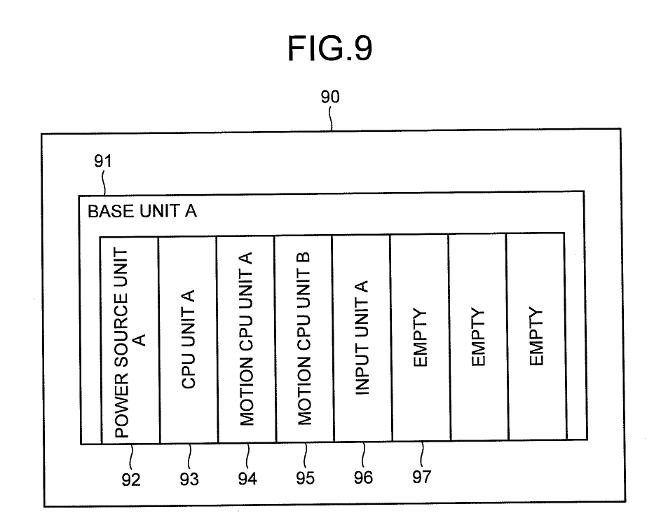

The PLC configuration diagram 90 indicates, as shown in FIG. 9, a configuration diagram in a case of the unit configuration table 61, in which a power source unit A (92), a CPU unit A (93), a motion CPU unit A (94), a motion CPU unit B (95), and an input unit A (96) are respectively arranged and displayed on a slot of the base unit A (91) as unit image data. When there is no unit arranged on a slot, it can be understood that any unit is not arranged as indicated by empty (97).

Next, functions and operations of the project allocating unit 31a, the unit-configuration analyzing unit 31b, the project acquiring unit 31c, the parameter reading unit 31d, the parameter writing unit 31e, the consistency checking unit 31f, and the project-usage-status checking unit 31g are explained.

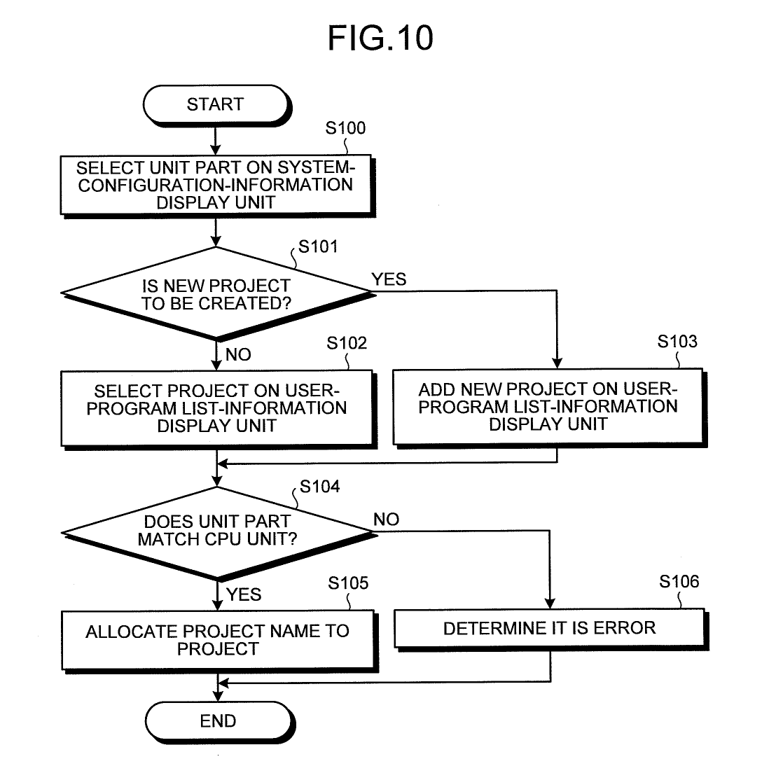

The project allocating unit 31a has a function of allocating a project to a CPU. FIG. 10 is a flowchart explaining an operation of the project allocating unit 31a for allocating a project to a CPU.

As shown in FIG. 10, a user selects a desired unit part of the unit parts displayed on the system-configuration-information display unit 12aa by using the input device 11 (Step S100), and the user determines whether to create and allocate a new project to the unit part selected by the user (Step S101). When a new project is not created (NO at Step S101), the user selects a project to be allocated to the selected unit part from the user-program list-information display unit 12b (Step S102). When a new project is created and allocated (YES at Step S101), the user newly creates and adds a project to be allocated to the selected unit part in the user-program list-information display unit 12b (Step S103). The project allocating unit 31a determines whether the selected unit part matches the CPU (Step S104). Specifically, the project allocating unit 31a acquires the unit information 62 of the unit part from the unit configuration table 61 based on the object ID of the selected unit part and determines whether the unit part is the CPU based on the attribute information 61d in the unit information 62. When the unit part matches the CPU (YES at Step S104), the project allocating unit 31a stores the selected project name into the project name 61f of the unit information 62 corresponding to the unit part, and allocates the project to the unit part (Step S105). When the unit part does not match the CPU (NO at Step S104), because the selected unit part is not the CPU unit or the motion CPU unit, the project allocating unit 31a determines that it is an error (Step S106). In this manner, the project allocating unit 31a can allocate a project to the unit part.

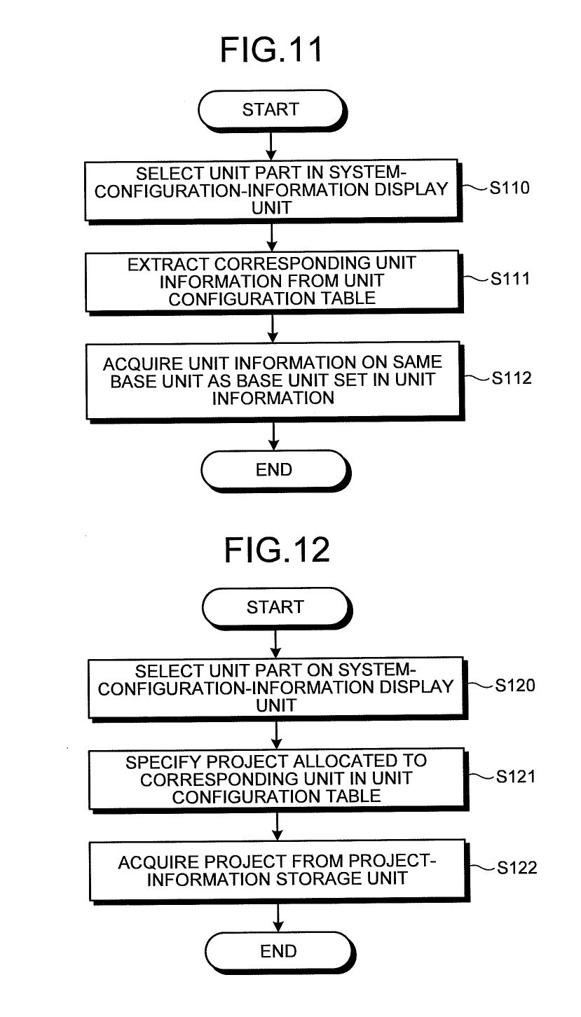

The unit-configuration analyzing unit 31b acquires a list of the unit information 62 of the CPUs having a multi-CPU relationship from the unit configuration table 61 which includes the unit part selected by the user therein. FIG. 11 is a flowchart explaining an operation of the unit-configuration analyzing unit 31b. In FIG. 11, when the user selects a unit part displayed on the system-configuration-information display unit 12aa by using the input device 11 (Step S110), the unit-configuration analyzing unit 31b extracts and acquires the unit information 62 corresponding to the selected unit part based on the object ID from the unit configuration table 61 including the unit part selected by the user (Step S111). The unit-configuration analyzing unit 31b acquires the list of the unit information 62 of a CPU unit and a motion CPU unit on the same base unit as the base unit set in the acquired unit information 62, that is, the unit parts having the multi-CPU relationship (Step S112). In this manner, the unit-configuration analyzing unit 31b can acquire the list of the unit information 62 of the unit parts having a multi-CPU relationship based on the unit information 62.

The project acquiring unit 31c can acquire the project allocated to the selected unit part. FIG. 12 is a flowchart explaining an operation of the project acquiring unit 31c. When the user selects the unit part displayed on the system-configuration-information display unit 12aa by using the input device 11 (Step S120), the project acquiring unit 31c acquires the unit information 62 corresponding to the selected unit part from the unit configuration table 61 in order to specify a project allocated to the unit based on the project name 61f held in the unit information 62 (Step S121). The project acquiring unit 31c acquires the appropriate project from the project-information storage unit 33c based on the acquired project name 61f (Step S122). As described above, the project acquiring unit 31c can acquire the project allocated to the selected unit part.

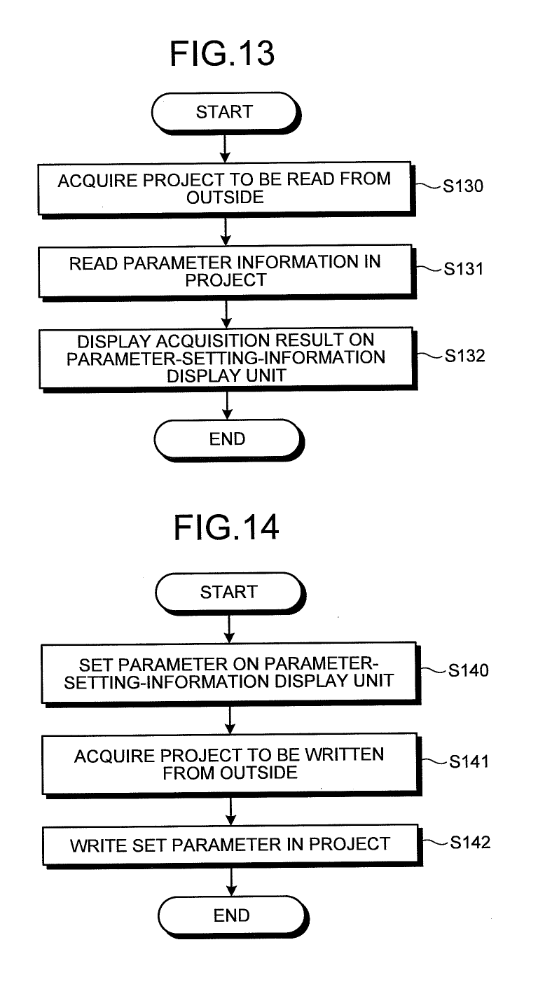

The parameter reading unit 31d reads parameters (multi-CPU parameters) to be collectively set from the project. FIG. 13 is a flowchart explaining an operation of the parameter reading unit 31d. The parameter reading unit 31d first acquires a project, which is specified from outside, from the project-information storage unit 33c (Step S130). The parameter reading unit 31d extracts the parameter information of parameters to be collectively set (multi-CPU parameters) (Step S131). The display processor 30 arranges for display the acquired multi-CPU parameters, and displays the multi-CPU parameters on the parameter-setting-information display unit 12ab as the multi-CPU parameter table 71 (Step S132). The parameter reading unit 31d can extract the multi-CPU parameters from the project and display these parameters in this manner.

The parameter writing unit 31e can set a parameter with respect to the specified project. FIG. 14 is a flowchart explaining an operation of the parameter writing unit 31e. The user first sets a parameter to be written on the parameter-setting-information display unit 12ab (Step S140). The parameter writing unit 31e acquires, from the project-information storage unit 33c, the project to be written specified from outside (Step S141). The parameter writing unit 31e then sets the parameter set at Step S140 with respect to an acquired project (Step S142). The parameter writing unit 31e can set the parameter with respect to the specified project in this manner.

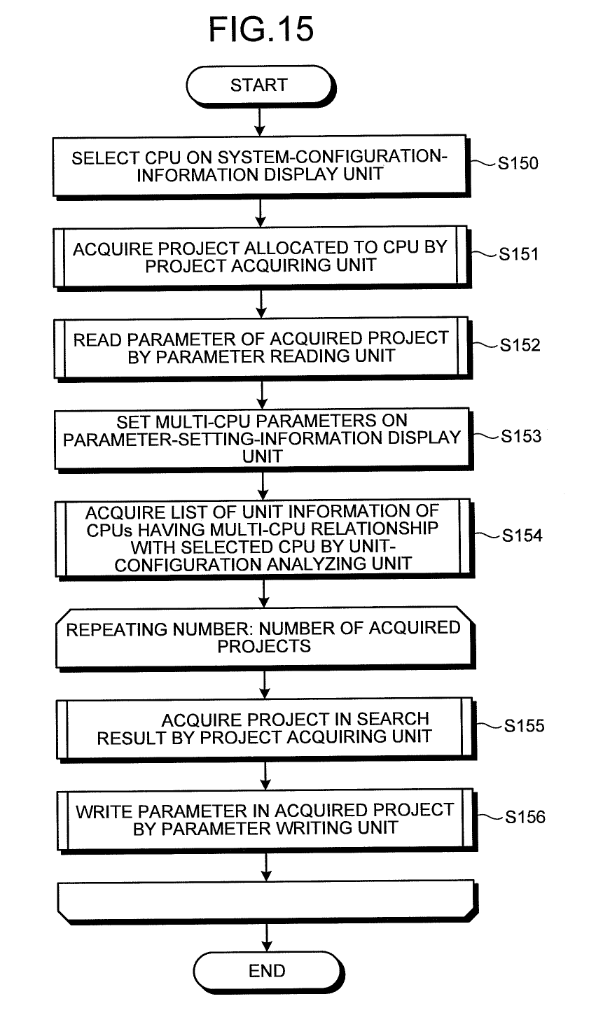

FIG. 15 is a flowchart explaining an operation of the parameter setting device 10 according to the embodiment of the present invention to collectively set parameters.

In FIG. 15, a user selects a CPU (a CPU unit or a motion CPU unit), for which a parameter is to be set, from the system-configuration-information display unit 12aa (Step S150). The project acquiring unit 31c acquires a project allocated to the selected CPU (Step S151). The parameter reading unit 31d reads the multi-CPU parameters from an acquired project (Step S152). The read multi-CPU parameters are displayed on the parameter-setting-information display unit 12ab. The use sets the multi-CPU parameters on the parameter-setting-information display unit 12ab (Step S153). The unit-configuration analyzing unit 31b acquires the list of the unit information 62 of the CPUs having a multi-CPU relationship with a selected CPU unit (Step S154). The project acquiring unit 31c acquires a project from the unit information acquired at Step S154 (Step S155), and the parameter writing unit 31e writes the multi-CPU parameters set at Step S153 in the acquired project (Step S156). Steps S155 and S156 are performed with respect to all CPUs having a multi-CPU relationship acquired at Step S154. The parameter setting can be collectively performed by one parameter setting operation with respect to the projects of all CPUs having a multi-CPU relationship.

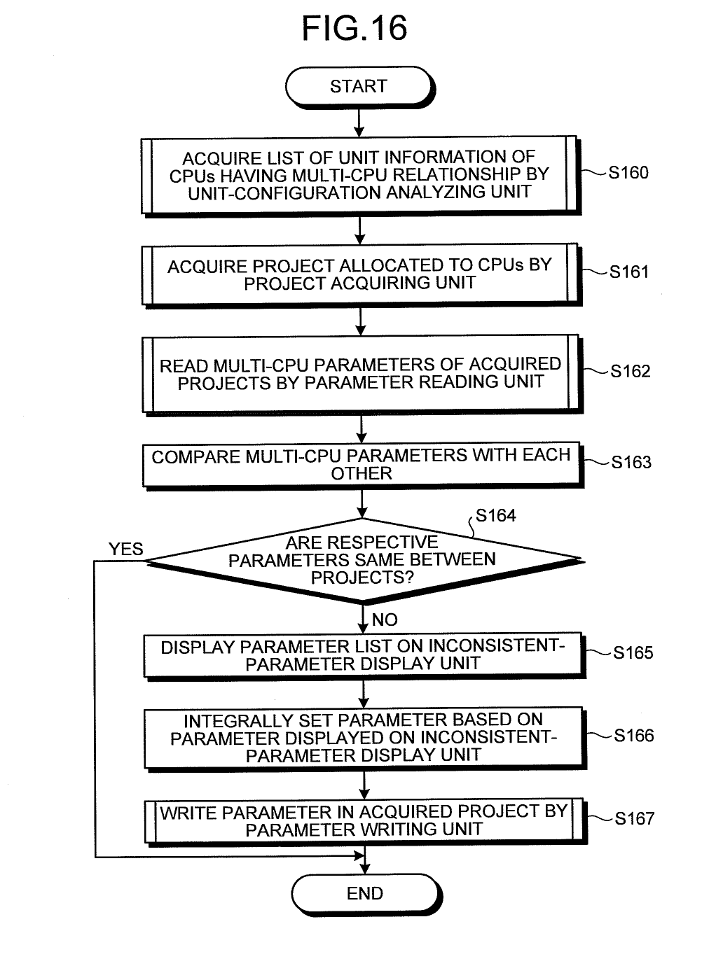

The consistency checking unit 31f can maintain consistency by detecting inconsistency between parameters and performing resetting. FIG. 16 is a flowchart explaining an operation of the consistency checking unit 31f. The unit-configuration analyzing unit 31b acquires the list of the unit information 62 of the CPUs having a multi-CPU relationship from the unit configuration table 61, in which the unit part selected by the user is included (Step S160). The project acquiring unit 31c acquires the project allocated to each CPU from the acquired unit information 62 (Step S161). The parameter reading unit 31d reads the multi-CPU parameters set to respective acquired projects (Step S162). The consistency checking unit 31f compares the multi-CPU parameters between the respective acquired projects with each other (Step S163), and determines whether the respective parameters are unified with the same value between the projects (Step S164). When the multi-CPU parameters are the same (YES at Step S164), the operation is finished. When the multi-CPU parameters are not the same (NO at Step S164), that is, when it is determined that there is inconsistency, the consistency checking unit 31f displays the corresponding multi-CPU parameters in a list on the inconsistent-parameter display unit 12da (Step S165). The consistency checking unit 31f then sets the multi-CPU parameters through the arithmetic unit 31 based on the multi-CPU parameters which have inconsistency and are displayed on the inconsistent-parameter display unit 12da (Step S166). The parameter writing unit 31e writes the multi-CPU parameters set at Step S166 in the respective projects (Step S167). In this manner, the consistency checking unit 31f can maintain the consistency by detecting the inconsistency between the multi-CPU parameters and performing resetting.

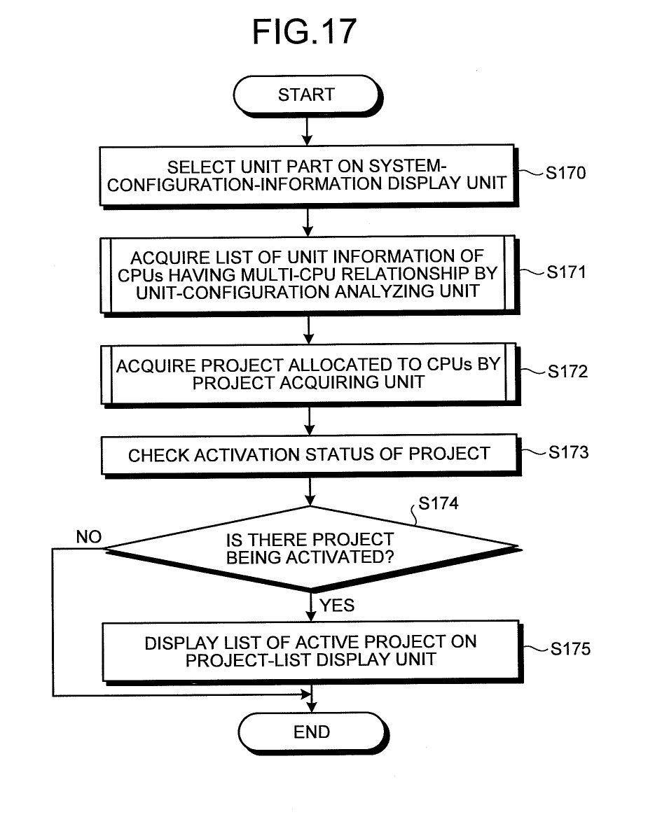

The project-usage-status checking unit 31g can check whether the project is being used. FIG. 17 is a flowchart explaining an operation of the project-usage-status checking unit 31g. The user first selects one unit part (Step S170). The unit-configuration analyzing unit 31b acquires a list of the unit information 62 of the CPUs having the multi-CPU relationship from the unit configuration table 61 that includes the unit part selected by the user (Step S171). The project acquiring unit 31c acquires a project allocated to each acquired CPU (Step S172). The project-usage-status checking unit 31g checks whether an acquired project is being used by another user (Step S173). Specifically, the project-usage-status checking unit 31g checks the usage status of the project based on the temporary file 81b of each project stored in the project-information storage unit 33c. The project-usage-status checking unit 31g determines whether the project is being activated with respect to a result of checking at Step S173 (Step S174). When it is determined that the project is not activated by another user (NO at Step S174), the operation is finished. When it is determined that the project is activated by another user (YES at Step S174), the project-usage-status checking unit 31g displays the corresponding projects in a list on the active-project display unit 12db (Step S175). The project-usage-status checking unit 31g can check whether the project to be written is being activated, and can ascertain whether writing can be performed. When the operation of Step S172 and the subsequent steps are performed immediately after Step S154 and the parameter collective setting operation is suspended at a time when reaching Step S175 through Step S174 (YES), inconsistency that is caused because the multi-CPU parameters cannot be set only to the active project can be prevented beforehand, so that this is convenient.

As described above, according to the first embodiment of the present invention, the parameter setting device includes the unit configuration information 60 for managing, for each PLC, the unit information 62 in which a CPU is associated with a project allocated to the CPU the unit-configuration analyzing unit 31b that extracts a list of the unit information 62 of CPUs provided in the same PLC in which the CPU specified by the user from the unit configuration information 60 is included; and the parameter writing unit 31e that, when the multi-CPU parameter of the project of the specified CPU is set, acquires each project of CPU units provided in the same PLC in which the specified CPU is included, based on the extracted list of the unit information 62, and writes a setting content same as the setting content with respect to the project of the specified CPU in each of the acquired projects. Therefore, the multi-CPU parameters included in the projects of respective CPUs having the multi-CPU relationship can be collectively set. The parameter setting device 10 also includes the consistency checking unit 31f that checks consistency of respective parameters between the multi-CPU projects by comparing the multi-CPU parameters set to the projects of the CPUs provided in one PLC with each other. Therefore, even when the multi-CPU parameters are individually changed in the respective projects after the multi-CPU parameters are collectively set, inconsistency can be detected by extracting a changed content. That is, the time required for the multi-CPU parameter setting can be considerably reduced, and a problem due to a parameter setting error can be avoided by decreasing a time for creation and ensuring consistency. Further, the project-usage-status checking unit is further provided that checks whether each of the acquired projects is being used when the parameter writing unit 31e is to set the setting content with respect to each of the projects, thereby enabling to save the effort of ascertaining the usage status of a project beforehand.

### INDUSTRIAL APPLICABILITY

As described above, the parameter setting device according to the present invention is preferable for a parameter setting device that sets a parameter to a project of a CPU unit provided in a PLC that controls an industrial machine and the like.

### REFERENCE SIGNS LIST

10 PARAMETER SETTING DEVICE

11 INPUT DEVICE

12 DISPLAY DEVICE

12a WORK DISPLAY UNIT

12aa SYSTEM-CONFIGURATION-INFORMATION DISPLAY UNIT

12ab PARAMETER-SETTING-INFORMATION DISPLAY UNIT

12aba PARAMETER-SETTING-ITEM SELECTING UNIT

12abb PARAMETER SETTING UNIT

12abba PLC-SYSTEM SETTING UNIT

12abbb DEVICE SETTING UNIT

12abbc I/O ALLOCATION SETTING UNIT

12abbd MULTI-CPU SETTING UNIT

12b USER-PROGRAM LIST-INFORMATION DISPLAY UNIT

12c UNIT-PARTS-INFORMATION DISPLAY UNIT

12d STATUS DISPLAY UNIT

12da INCONSISTENT-PARAMETER DISPLAY UNIT

12db ACTIVE-PROJECT DISPLAY UNIT

13 CENTRAL PROCESSING UNIT

14 MEMORY DEVICE

15 COMMUNICATION I/F DEVICE

16 COMMUNICATION LINE

17 PLC

30 DISPLAY PROCESSOR

31 ARITHMETIC UNIT

31a PROJECT ALLOCATING UNIT

31b UNIT-CONFIGURATION ANALYZING UNIT

31c PROJECT ACQUIRING UNIT

31d PARAMETER READING UNIT

31e PARAMETER WRITING UNIT

31f CONSISTENCY CHECKING UNIT

31g PROJECT-USAGE-STATUS CHECKING UNIT

32 INPUT PROCESSOR

33 STORAGE UNIT

33a UNIT-CONFIGURATION-INFORMATION STORAGE UNIT

33b UNIT-PARTS-INFORMATION STORAGE UNIT

33c PROJECT-INFORMATION STORAGE UNIT

34 COMMUNICATION PROCESSOR

50 BASE UNIT GROUP

50a BASE UNIT A

50b BASE UNIT B

50aa ATTRIBUTE INFORMATION 1

50ba ATTRIBUTE INFORMATION 2

51 CPU UNIT GROUP

51a CPU UNIT A

51b CPU UNIT B

51aa ATTRIBUTE INFORMATION 3

51ba ATTRIBUTE INFORMATION 4

52 MOTION CPU UNIT GROUP

52a MOTION CPU UNIT A

52b MOTION CPU UNIT B

52aa ATTRIBUTE INFORMATION 5

52ba ATTRIBUTE INFORMATION 6

53 INPUT UNIT GROUP

53a INPUT UNIT A

53b INPUT UNIT B

53aa ATTRIBUTE INFORMATION 7

53ba ATTRIBUTE INFORMATION 8

60 UNIT CONFIGURATION INFORMATION

61 UNTI CONFIGURATION TABLE

61a PLC CONFIGURATION NAME

61b SLOT NUMBER

61c UNIT NAME

61d ATTRIBUTE INFORMATION

61e OBJECT ID

61f PROJECT NAME

62 UNIT INFORMATION

70 MULTI-CPU PARAMETER INFORMATION

71 MULTI-CPU PARAMETER TABLE

71a PARAMETER TYPE

71b PARAMETER SETTING VALUE

80 WORK SPACE FOLDER

81 PROJECT FOLDER

81a PROJECT FILE

81b TEMPORARY FILE

90 PLC CONFIGURATION DIAGRAM

91 BASE UNIT A

92 POWER SOURCE UNIT A

93 CPU UNIT A

94 MOTION CPU UNIT A

95 MOTION CPU UNIT B

96 INPUT UNIT A

97 EMPTY

1. A parameter setting device that sets a parameter of a plurality of projects for respectively operating a plurality of CPUs provided in a programmable controller (PLC), the parameter being required for the CPUs to operate in conjunction with each other, with respect to each of the projects, the parameter setting device comprising:
unit-configuration-information storage unit that stores unit configuration information used for managing, for each PLC, unit information in which a CPU and a project allocated to the CPU are associated with each other;
a unit-configuration analyzing unit that extracts a list of unit information on CPUs provided in a same PLC that includes a CPU specified by a user from the unit configuration information; and
a parameter writing unit that
acquires each project of CPU units, which are provided in a same PLC in which the CPU is included, based on the extracted list of unit information, when a parameter of a project of the specified CPU is set, and
sets a setting content, which is same as a setting content regarding a project of the specified CPU, to each of the acquired projects.

2. The parameter setting device according to claim 1, further comprising a consistency checking unit that checks consistency of parameters between the plurality of projects by comparing parameters set to projects of CPUs provided in one PLC with each other.

3. The parameter setting device according to claim 1, further comprising a project-usage-status checking unit that checks whether each of acquired projects is being used, before setting the setting content to each of the projects acquired by the parameter writing unit.

4. The parameter setting device according to claim 1, wherein the CPU is a CPU unit and/or a motion CPU unit.
